(19) United States
(12) Patent Application Publication
(10) Pub. No.: US 2005/0108094 A1
(43) Pub. Date: May 19, 2005

(54) Method for making a decision according to customer needs

(76) Inventors: Philippe Hugron, Verdun (CA); Jean-Francois Berube, Montrial (CA)

Correspondence Address: OGILVY RENAULT, 1981 MCGILL COLLEGE AVENUE, SUITE 1600, MONTREAL, QC, H3A2Y3, CA

(21) Appl. No.: 10/962,587

(22) Filed: Oct. 13, 2004

Related U.S. Application Data
(60) Provisional application No. 60/520,663, filed on Nov. 18, 2003.

(51) Int. Cl. G06F 17/60

(52) U.S. Cl. 705/14

(57) ABSTRACT

A method for suggesting a product from a set of products at a retail point according to customer needs is presented. The method includes the steps of determining a set of consumer needs relating to a product type; creating a set of questions to be answered by a consumer, the set of questions relating to the set of possible consumer needs; determining a grading for the products for each of the possible consumer needs; obtaining from the consumer answers to the set of questions and determining from the answers a weighting of importance of the consumer needs; using the grading and the weighting to calculate a score for each product of the set of products and using the scores to differentiate between products such as to suggest to the consumer a product that best satisfies the expressed consumer needs.

### CROSS-REFERENCE TO RELATED APPLICATIONS

The application claims priority under 35USC§119(e) of U.S. provisional patent application 60/520,663 the specification of which is hereby incorporated by reference.

### FIELD OF THE INVENTION

The invention relates to computer based decision systems. More specifically, it relates to computer based systems assisting in the decision making process by providing a ranking and selection of products from records of a database, based on customer parameters, such as needs, profile and budget.

### BACKGROUND OF THE INVENTION

Retailers are always looking for ways of increasing their sales and the interaction between sales personnel and customers has usually been the driving force behind revenue growth. Sales personnel are responsible for inquiring about the customer's needs, evaluating them and then, based on their knowledge of a retail point's inventory, assist the customer in making an informed buying decision. Customers value the idea that the product purchased meets exactly their needs. Furthermore, customers appreciate the consistent personalized attention and service they receive from sales personnel. It is well-known in the retail industry that a long-term relationship between staff and customers proves profitable for the retailer.

The drawback to this situation is that the sales personnel turnover rate is high. Moreover, sales positions are often open to a wide variety of backgrounds and experience. As a results, oftentimes, recruiting and training well-qualified sales personnel becomes a tremendous expense for a retailer. There exists therefore a need for a cost-effective method of providing personalized sales assistance that takes into account customer needs and preferences.

Moreover, when sales assistants leave, so does their valuable acquired knowledge about the customer needs, preferences, the latest market trends, etc. Such information on customer profiles, if consolidated, can prove to be a valuable tool for a retailer in directing advertising campaigns, improving marketing communications, as well as benchmarking products against the competition. There exists therefore a need for a method of gathering customer-buying preference information and storing it for marketing and selling purposes.

In the past, systems have been developed to solve these problems, such as the Guided Assistants and the supporting platform developed by Active Decisions Inc., but they suffer from several drawbacks. Guided Assistants are automated systems that take the customer through a question-and-answer process to detect their needs concerning the products at the retail point. The system works by narrowing the pool of existing products to a set of recommended products by determining the direct relationship between a customer need and a product characteristic, and further assessing this product characteristic in order to rank the product. In other words, the prior art system works by assessment of individual criteria and it does not provide for a way of evaluating the product globally. Such a simplistic approach therefore cannot guarantee that the set of solutions provided are accurate, in the sense that they constitute the optimal set of products corresponding to the customer needs.

### SUMMARY OF THE INVENTION

Accordingly, an object of the present invention is to offer a cost-efficient method for providing customized purchasing assistance by taking into account customer needs and preferences.

According to a broad aspect of the present invention, there is provided a method for suggesting a product from a set of products at a retail point according to customer needs. The method includes the steps of determining a set of consumer needs relating to a product type; creating a set of questions to be answered by a consumer, the set of questions relating to the set of possible consumer needs; determining a grading for the products for each of the possible consumer needs; obtaining from the consumer answers to the set of questions and determining from the answers a weighting of importance of the consumer needs; using the grading and the weighting to calculate a score for each product of the set of products and using the scores to differentiate between products such as to suggest to the consumer a product that best satisfies the expressed consumer needs.

Another object of the present invention is that of providing a system that is user-friendly, easy to set up and provides improved personalized assistance to customers.

According to another broad aspect of the invention, there is provided a method for generating a text containing an assessment of a product according to a set of consumer needs, comprising: for each consumer need, providing a plurality of text fragments describing the product in consideration of the consumer need, the plurality of text fragments differing from one another in consideration of an importance of the consumer need with respect to a given consumer; determining for a given consumer, from consumer answers to a questionnaire, a weighting of importance of the consumer needs; for each consumer need, selecting one of the text fragments according to a weighting of importance of the consumer need; compiling all selected text fragments into a text for the given consumer.

For the purpose of the present invention, the following terms are defined below.

Model: A model is the representation for purposes of analysis of a product or a service for which a customer wishes more information.

Product: A product is an instance of a model. A given model can be used to represent many different products from the same product line. A customer who is interested in purchasing a given model will be able to choose between different products.

Example: desktop computer.

Branch: A branch is an attribute specification of the model. A branch is quantified or described by a leaf (or another branch-leaf combination?).

Example: processor.

Leaf: A leaf is a characteristic of an attribute specification. Leaves are elements that allow to differentiate between different products. Example: Speed.

Leaf factor: A list of all possible values for a given leaf.

Example: Set of all processor speeds, e.g. 500 MHz, 550 Mhz, 600 Mhz, etc.

Criteria: A criteria is the association between a branch and one of its leaves. A criteria represents a selection element for a given product. The value of a criteria is important for customer and it allows the decision system to select a product that satisfies a set of given customer needs.

Example: processor speed

Data value: A data value is an instance of a criteria. A data value quantifies or describes a criteria.

Example: processor speed of 1.2 GHz.

Customer: A customer is a person interacting with the system such that they may receive guidance and assistance regarding a particular product, a desired service, etc.

### BRIEF DESCRIPTION OF THE DRAWINGS

These and other features, aspects and advantages of the present invention will become better understood with regard to the following description and accompanying drawings wherein:

FIG. 1 is a block diagram of a decision system according to a preferred embodiment of the present invention;

FIG. 2 is a screenshot of an exemplary database model for a computer product according to a preferred embodiment of the present invention;

FIG. 3 is a block diagram of an exemplary database model structure for a computer product according to a preferred embodiment of the present invention;

FIG. 4 is a screenshot of an exemplary creation of the database of product information according to a preferred embodiment of the present invention;

FIG. 5 is a flow chart of a method for suggesting a product according to consumer needs, according to a preferred embodiment of the present invention;

FIG. 6 is a screenshot of an exemplary questionnaire creation according to a preferred embodiment of the present invention;

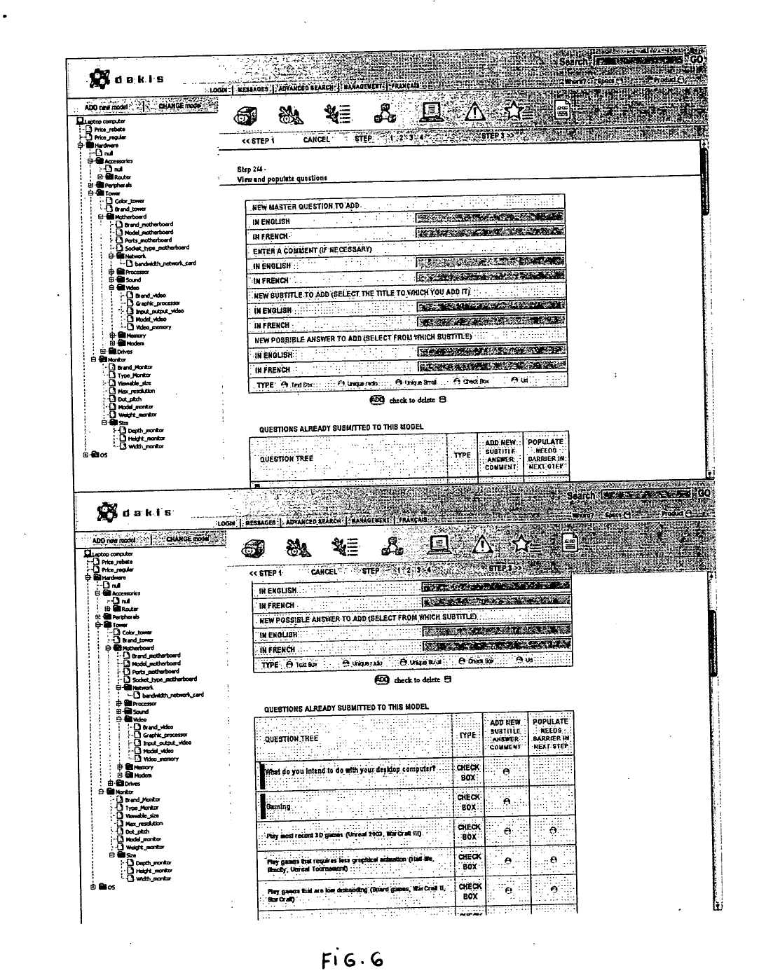

FIG. 7 is a screenshot of an exemplary creation of associations between questions and criteria according to a preferred embodiment of the present invention;

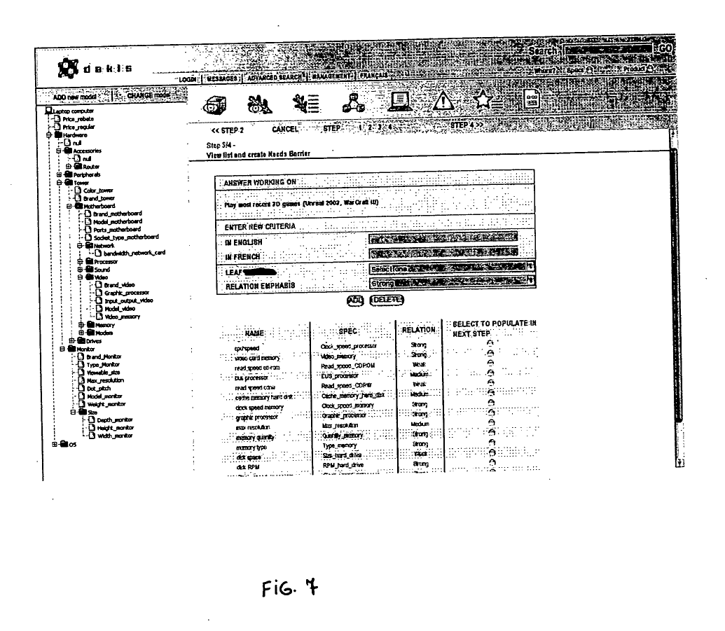

FIG. 8 is a screenshot of an exemplary classification of data values in different categories according to a preferred embodiment of the present invention;

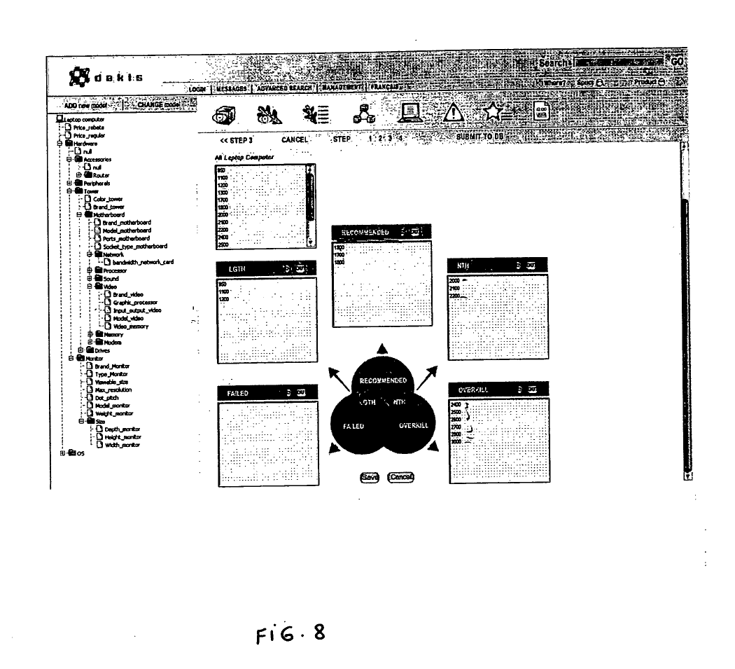

FIG. 9 is an exemplary Venn diagram of classification categories according to a preferred embodiment of the present invention;

FIG. 10 is a detailed block diagram of some components of the decision system according to the present invention;

FIG. 11 is a flow chart of a method of generating text according to an alternative embodiment of the present invention;

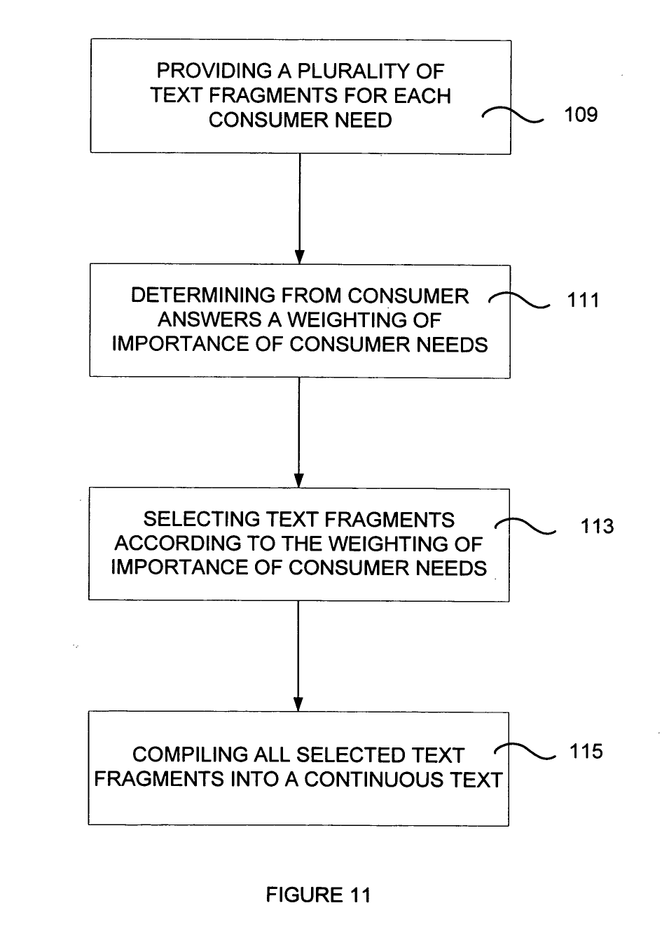

FIG. 12 is a screenshot of an exemplary user interface showing a choice of business tools, within a system implementing the method of the present invention;

FIG. 13 is a screenshot of an exemplary user interface showing a choice of product lines, within a system implementing the method of the present invention;

FIG. 14 is a screenshot of an exemplary user interface showing a questionnaire for evaluating the customer's needs, within a system implementing the method of the present invention;

FIG. 15 is a screenshot of an exemplary user interface showing product recommendations according to the customer's needs, within a system implementing the method of the present invention.

### DETAILED DESCRIPTION OF THE PREFERRED EMBODIMENT

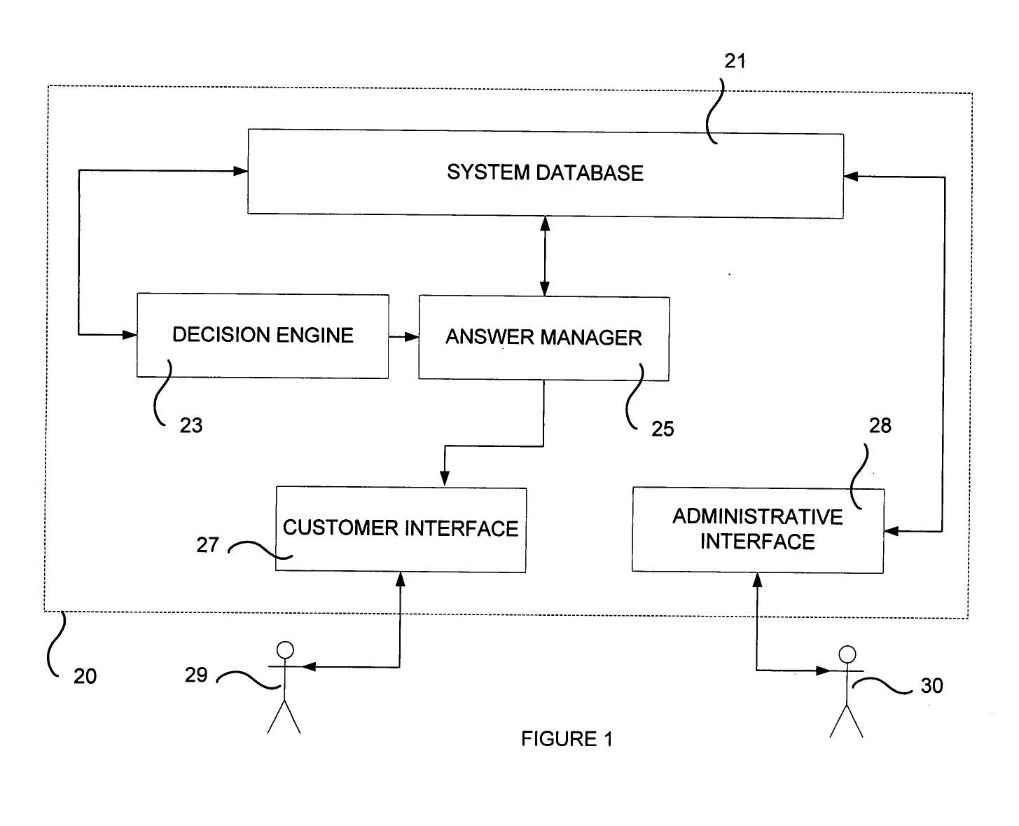

A preferred embodiment of the present invention will be described with respect to FIG. 1, which is a block diagram of a decision system 20. A potential customer 29 may interact with the decision system 20 through a terminal located at a certain retail point or through a web interface. In a first step, information about products in the retail point inventory must be stored in an organized manner in a system database 21. The decision system 20 can offer purchasing assistance with respect to products from a variety of fields such as, electronics equipment, sports equipment, vacation packages, etc. and within each field, different lines of products might be described.

The description of the preferred embodiment will be made in reference to electronics equipment available at a certain retail point. For example, at such an electronics equipment retail point, the database of products might be configured to contain information about desktop computers, laptop computers, computer monitors, cellular phones, speakers, computer printers, computer peripherals, digital cameras, television sets, satellite systems, etc. In the system database 21, to each line of product corresponds a respective database configuration or model, containing the necessary product attribute specifications to describe an individual product and to distinguish it from products of the same line.

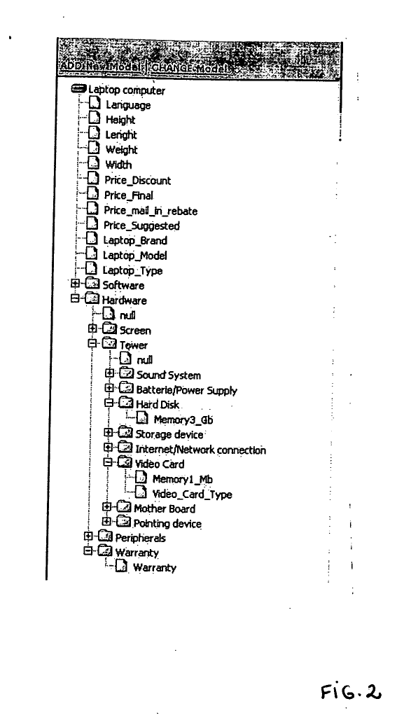

The creation of an exemplary database model for electronics equipment will now be described in reference to FIG. 2. The database model is preferably created by a member of the sales personnel at the same retail point at which the decision system 20 will be installed. Though the task of creating the database model requires using a computer system, the person chosen for this task does not need to possess any advanced knowledge of programming, but instead needs to be knowledgeable with respect to the line of products described in the system database 21. Such a person, that we will refer to as an analyst 30, must be capable of determining which are the defining and differentiating attributes of each product in a given product line. The analyst 30 interacts with the decision system 20 through an administrative interface 28 which provides access to system configuration and setup tools.

In the preferred embodiment of a decision system 20 installed in an electronics equipment retail point, the analyst 30 might proceed with determining the attributes and characteristics of, for example, desktop computers. Once the defining attributes are determined, the analyst 30 organizes them hierarchically in order to define the database model. The hierarchical organization is preferably a tree-like structure of nested components and their respective attributes.

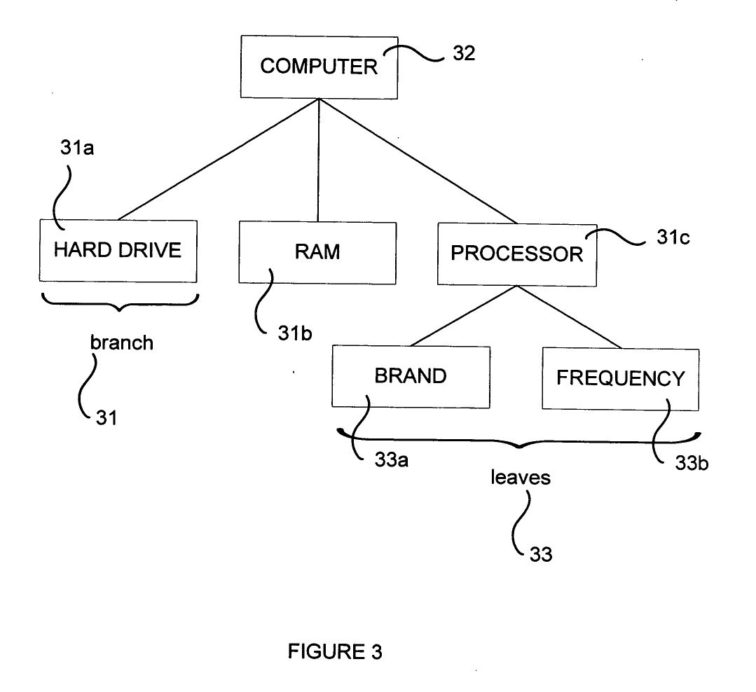

For example, with respect to FIG. 3, the structure of an exemplary database model for a desktop computer 32 will be described: a processor 31c is a branch 31 of the model, while frequency 33b is a leaf 33 of the model. A branch 31 is therefore understood to be a product attribute that is defined with at least one more level of complexity. A leaf 33 is understood to mean a product attribute which is not further defined and must be used together with its branch 31, i.e. processor frequency. A leaf 33 together with its branch 31 will be referred to as a criteria, while leaf factors is defined to be the set of all possible values that a leaf can take on. For example, for a “processor frequency” the set of leaf factors might include values such as 800 MHz, 1 GHz, 1.2 GHz, 1.6 GHz, 2.0 GHz and the like.

The analyst 30 has the choice between defining a database model representative of only products found in the electronics equipment retail point inventory or creating a more complete model, that could eventually be used for incorporating new products existing on the market. The advantage of defining the more complex model early on is that the database model would not need to be modified to accommodate the addition of new products to the retail point inventory.

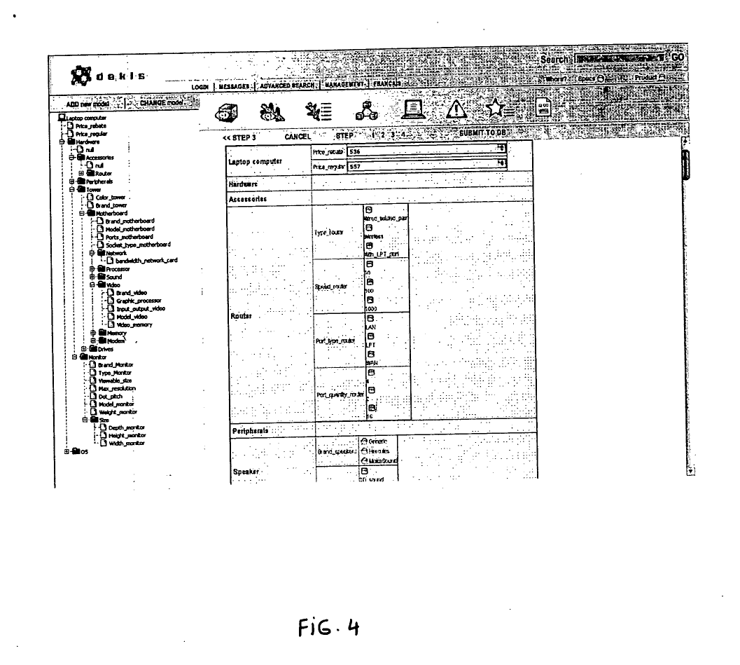

With respect to FIG. 4, the creation of the database of products will now be described in more detail. At this step, the analyst 30 maps the product's characteristics and attributes to the database model describing the product. For each product, the analyst 30 will enter data values for all product criteria, such as to provide complete specifications describing the product. A specification is a criteria together with a value that defines it. For example, a “processor frequency of 1.5 GHz” is a specification.

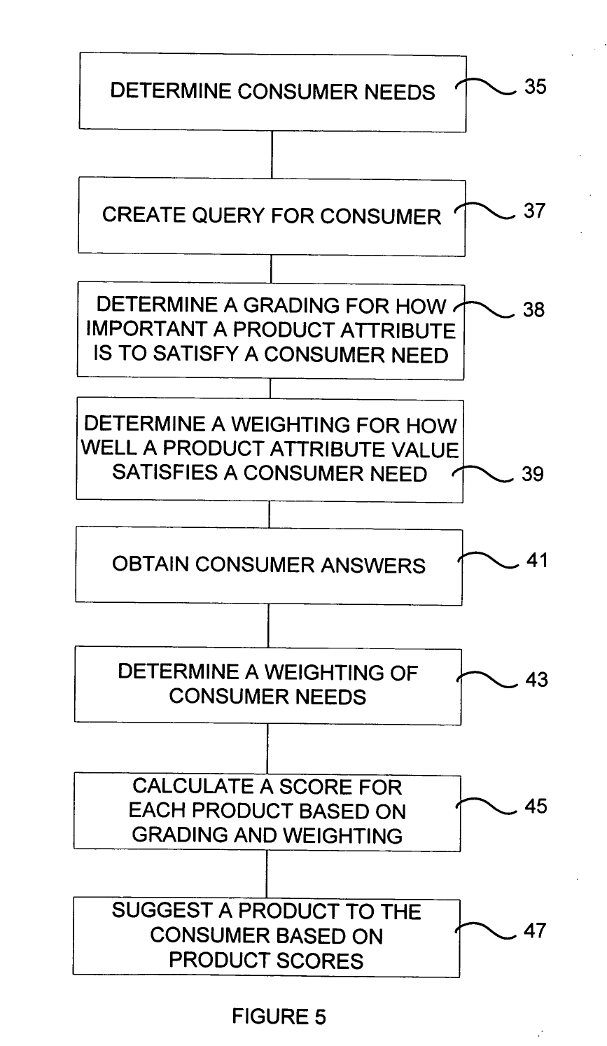

With respect to FIG. 5, the creation of the customer questionnaire will now be described. The goal of the questionnaire is to gather information about a given customer's needs. The questionnaire may only be created once a set of possible customer needs have been identified. The analyst 30 therefore considers the needs of a potential customer 29 for a specific product line. For computers, such needs might include: playing video games, browsing the Internet, editing high-quality images, etc. As per step 37, the analyst 30 prepares a set of questions with a set of answers, from which the customer 29 will have to choose those that closely match his profile. In the preferred embodiment, the questions should be ordered in the same order in which the customer will view them. In alternative embodiments, and as it can be appreciated by one skilled in the art, a question manager function could selectively present next questions as a function of answers to previous questions and thus, decide on the ordering of the questions dynamically. The questions will be answered by the customer as per step 41.

In accordance to step 38, for each question, corresponding to a specific customer need, the analyst 30 will then create a grading for each criteria. At this step, the analyst 30 will go through all combinations of branches and leaves, that is, will assess all product criteria, and will determine to what extent the given criteria affects the given customer need. In the preferred embodiment, the analyst 30 has the choice between 3 levels of grading: strong, medium and weak. A strong grading for an association question/criteria would mean that the given criteria strongly affects the given need. For example, in the case in which a customer has selected “playing 3D computer games” as a need, the “CPU speed” and “video card memory” criteria will receive a strong grading for that need. For the same need, a criteria such as “bus processor” will receive a “medium” grading, since the performance of the bus processor affects less the ability to play 3D computer games. Also for the same need, a criteria such as “CD-ROM read speed” might receive a “weak” grading since it barely influences the given need.

As another example, a need for “playing on-line computer games” will influence all criteria related to the “network card”. A need may influence an indefinite number of criteria.

For calculation purposes, to each grading option corresponds a particular grading value.

In a next step 39, the decision system 20 creates an association between each question and a criteria that it influences. A criteria has been defined to represent the association of a leaf together with its branch, describing a product attribute. Then, for a given criteria, all data values that it can take on are evaluated with respect to the question. Following evaluation, a particular data value is classified according to how well it satisfies the need expressed by that particular question. As an example of such a classification, a data value could: not satisfy the given need (failed), satisfy the need but not be ideal (less good to have), satisfy the need (recommended), satisfy the need very well (nice to have) or satisfy and surpass the need (overkill).

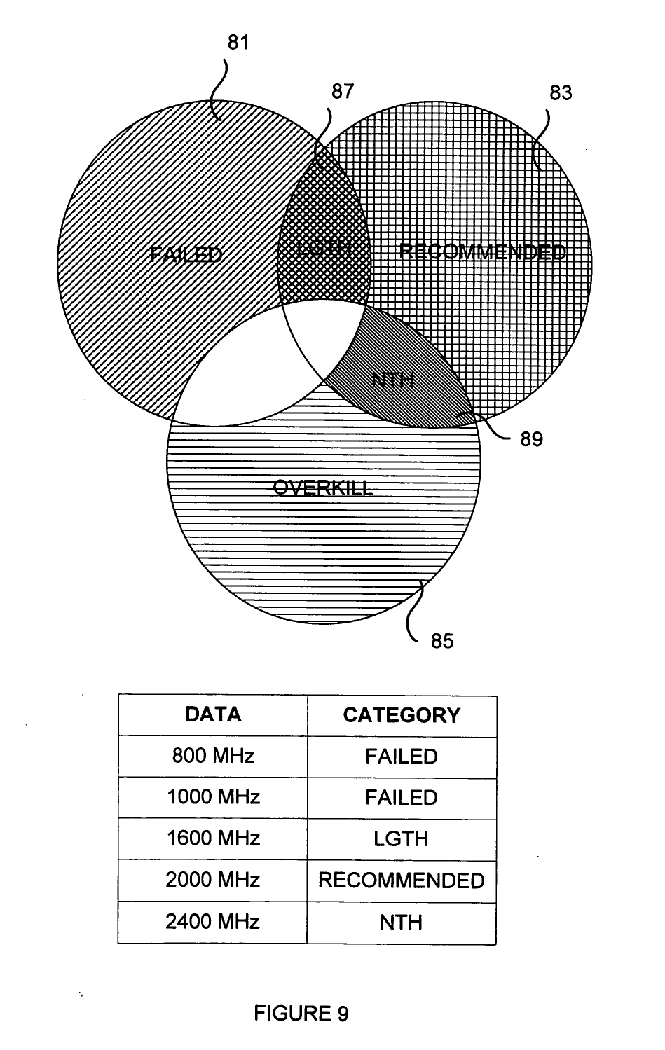

The classification of data values for an association question/criteria could be illustrated using a Venn diagram, such as the one shown in FIG. 9. Category “failed” 81 contains data values that do not satisfy a given need, category “recommended” 83 contains data values that satisfy the need and category “overkill” 85 contains data values that surpass the requirements of a given need. Intermediate category “LGTH” 87 contains data values that satisfy a given need but are not ideal, while category “NTH” 89 contains data values that satisfy the need very well.

The different classification categories of the Venn diagram are the need barriers of the decision system 20. Each classification category is assigned a weighting value, according to a given point distribution scheme. Each of the data values are therefore given weighting values corresponding to the category they are classified in. However, data values in the same category do not necessarily receive the same weighting value. The weighting value given to a particular data value in a category may be higher or lower than the average weighting value for the category, but within the bounds of the category. The upper bound is the smallest weighting value in the next classification category up and the lower bound is the highest weighting value in the next classification category down. (Note: Please give example of points distribution here for different weighting values)

The weighting points value of each data value is later used by the decision engine 23 in the calculation of product scores for each product.

After having evaluated all data values for a given association question/criteria and having classified them, not all classification categories will necessarily contain a data value. Indeed, there can be more than one data value in a given classification category, as well as classification categories which do not contain any data values.

The data values lying in the intersection area of the “failed” and “less good to have” categories are considered “must have” elements by the decision system 20. These elements constitute the threshold for the minimum acceptable performance of a product for that given criteria. All data values less than the “must have element” for a given criteria will be placed in the “failed” classification category. In the preferred embodiment, a product having a criteria classified in the “failed” category will automatically be dismissed from the pool of potential recommended products. This follows from the fact that if a criteria is classified as “failed” it means that it does not satisfy a certain expressed customer need, at which point it cannot be recommended to that customer.

However, the classification categories can be parameterized and can be set to include in the solution all products, even those having one or more “failed” criteria, or, for example in a more restrictive scheme, to exclude even those products that have a “less good to have” criteria.

An important feature of the decision system is the fact that it can be parameterized to contain different decision profiles. A decision profile may specify the points distribution for each classification category and within each category, as well as define the standards for including a product in the final list of recommended solutions. A decision profile may also specify the criteria for ranking the products in the final list of recommended solutions.

Whenever the system executes the algorithm for taking a decision, it will do so for all existing decision profiles. It is therefore recommended to minimize the number of existing decision profiles so as not to increase the execution time to an unacceptable level. In the preferred embodiment of the present invention it is recommended that the number of decision profiles per system does not exceed three.

After all data values have been evaluated, the decision engine 23 can calculate a score for each product described in the system database 21. In order to calculate the score for a given product, the decision engine 23 must take into account:
1) the grading points value of all associations question/criteria that have been selected by the customer,
2) the weighting points value of data values for each criteria of the given product

The score for a given criteria is then calculated by multiplying the grading points value and the weighting points value. Then, according to step 45, the total score for a given product is calculated by summing the score of each criteria for that product.

The calculation process as described above is however time-consuming and, if implemented as such, would increase the response-time to a level that is unacceptable for an interactive system. In the preferred embodiment, the calculation process has therefore been modified to execute according to a different algorithm. According to the new sequence of steps, the calculations have been separated in two sets: those that can be executed prior to interaction with the customer and those that need to be executed in real-time, as they require information from the customer.

In the preliminary step, for each product in the database, the system compiles a series of associations between different fields, which are then stored to be used in the real-time execution and calculation step. More precisely, in this preliminary step, the decision system will run a series of queries on the database to collect and structure the information needed to later compile a score for each product, based on the customer needs.

The compilation of information in the preliminary step will be described for a single product and it will be understood that the same algorithm is applied for all products available in the system database 21. First, for a particular instance of a product, the tree-like structure of the product description will be traversed to identify all criteria for that product. For each criteria, the decision system 20 identifies all associations question/criteria recorded in the system database 21. Such a query returns a list of all criteria where, for each criteria, the question of the association and the grading points value of the association are specified.

In a next step, the system 20 executes another query in order to retrieve, for each criteria in a product, its actual data value and the weighting points value attributed to this data value. If no data value is found to have been specified for a particular criteria, the system checks whether “none” is a possible data value (part of the leaf factor set). If “none” is a possibility for the given leaf, in other words, if it is not necessary that the product has the feature described by the criteria, then the system retrieves the weighting points value for a “none” value.

If it is found that “none” is not a possibility for the given leaf, then it is assumed that all valid products should have a data value defined for the given criteria. Since the product is not valid, the weighting points value will automatically be set to “failed”.

In a next step, the information retrieved in the previous two steps is consolidated in one preliminary table linking together information about the model, the product, the branch, the criteria, the question, the data value, the grading points value and the weighting points value. The information is stored in the system database 21 in a structure called a pre-stamper. The pre-stamper contents will be used by the decision system 20 to suggest a product after a customer 29 provides information about his needs in the form of answering the questionnaire.

The steps described so far are executed before the customer 29 provides any input to the decision system 20. The steps performed in real-time will now be described. After the customer submits all answers to the questionnaire, the decision system 20 will be presented with a list of the questions that have been answered positively by the customer 29. This list of questions is used to create a stamper structure 93, which is a table containing the entries of the pre-stamper 99, but only for the questions that have been answered positively by the customer 29. The stamper structure 93 therefore presents concisely all information that is needed in order to calculate a product score for each product. The pre-stamper structure 99 is useful in that it tremendously reduces the time necessary to gather all the information from the different modules of the system database 21.

In a next step, the decision engine 23 creates a temporary structure storing each product described in the system database 21 and its associated product score. The product score value is initialized to 0 at this stage, before any calculations have taken place. The decision engine 23 also creates a decision matrix 91, which is a structure containing enough information allowing the decision system 20 to provide a final assessment of the suitability of existing products. In the preferred embodiment of the present invention, the decision matrix 91 contains information such as, product identification information, profile information, the calculated product score according to the given profile, a flag indicating whether or not the product should be considered for the final set of recommended products and a ratio of the score to the price, as additional ranking criteria.

Then, for all entries in the stamper structure 93, the decision engine 23 calculates a score for each product. The product score is calculated by multiplying the grading points value by the weight points value for each criteria and then summing all individual criteria scores.

The decision engine 23 computes at the same time a ratio between the calculated product score and the product price, which can be used as a ranking criteria for the set of recommended product solutions. The Decision system 23 may also take into account a field indicating whether the product satisfies all customer needs.

In another embodiment of the present invention, the step of ranking the products according to consumer needs may comprise using a global ranking of all products for the existing consumer needs. While it can be appreciated that such a method may be easier to implement, it may prove to be less reliable due to analyst 30 subjectivity in globally ranking the products.

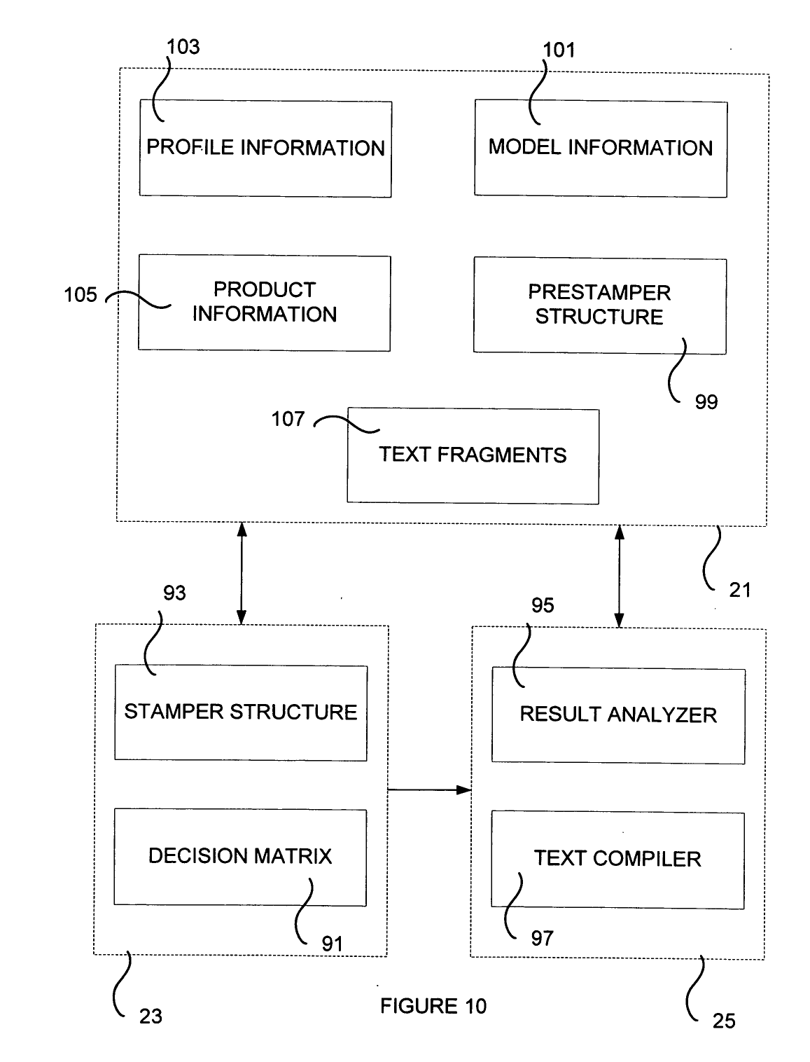

Now, with respect to FIG. 10, which is a detailed block diagram representing the key components of the decision system 20, some other characteristics will be described. An important feature of the decision system 20 is its ability to provide a set of product recommendations to the client together with a text description containing an explanation as to the strengths and weaknesses of each product, as they relate to the customer's needs. The decision system 20 features an answer manager 25, which is the module responsible for interpreting the decision system 20 results as stored in the decision matrix 91. The answer manager 25 uses the contents of the system database 21, to compile a text description for each of the products. The answer manager 25 contains a result analyzer 95, which is a module in communication with the decision matrix 91 of the decision engine 23. The answer manager 25 is also in communication with the decision system database 21 for accessing the text fragments 107 stored therein. The text fragments 107 are words and groups of words describing a given product for each product attribute specification and for each consumer need, differing from one another depending on how well a product attribute specification value satisfies a given consumer need and on how essential that product is for satisfying the given need.

The answer manager 25 also contains a text compiler module 97. The text compiler 97 module compiles text fragments 107 into a text to be displayed for each product of the set of recommended products for a given consumer.

In the preferred embodiment of the present invention, a plurality of text fragments 107 are provided for a given product and for each product attribute specification. The text describes how essential a given product attribute specification is for satisfying a given need (high, medium, low) and how well the product attribute specification value satisfies the given need. The text fragments 107 are directly related to the results stored in the decision matrix 91 and the grading values and weighting values for the product attributes. The selection of the text fragments 107 is done according to the grading value and weighting value for each product attribute specification for a given need.

In an alternative embodiment of the present invention, in a first step 109, a plurality of text fragments are provided for each product, for each consumer need, describing the product in consideration of the consumer need, the text fragments 107 differing from one another in consideration of an importance of the consumer need with respect to the given consumer. In a following step 111, the system determines from the consumer answers to the questionnaire, a weighting of importance of consumer needs. In accordance with a next step 113, the text fragments 107 are selected according to the weighting of importance of consumer needs. Then, as per step 115, the text compiler 97 compiles all selected text fragments into a text for the given consumer.

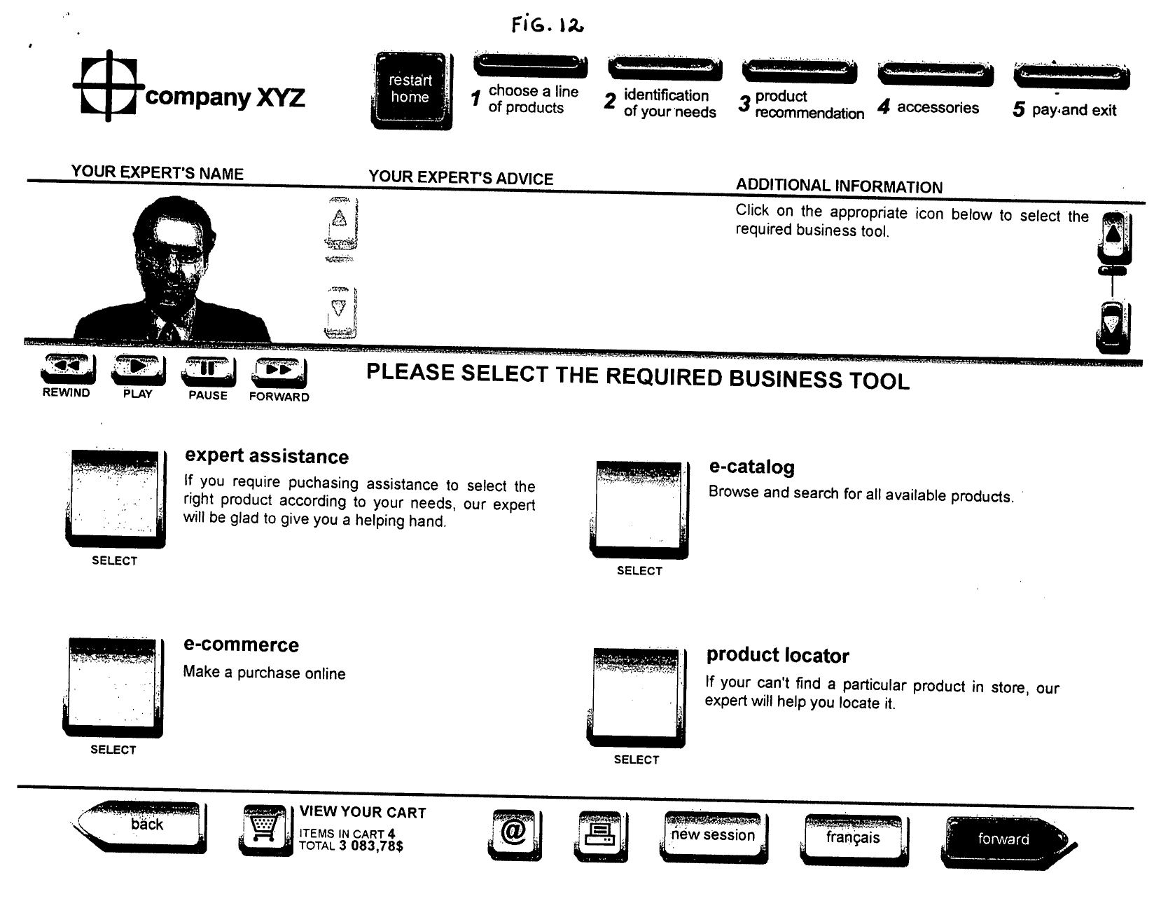

FIGS. 12-15 are screenshots from an exemplary customer interface 27 for implementing the method of the preferred embodiment. In one embodiment, the customer interface is configured for providing purchasing assistance to a customer 29 seeking purchasing assistance regarding a particular type of product, such as a desktop computer. In alternative embodiments, when the customer 29 may seek purchasing assistance relating to a different type of product, the user interface is customized to prompt and guide the customer depending on the specific type of product. The user interface is customized for example by modifying the specific questions and prompts to the customer for information relating to the customer needs.

With respect to FIG. 12, the interaction of a potential customer with the system will now be described. A customer seeking product information regarding a product line of interest access a menu screen of the system. The menu screen includes a listing or menu of a plurality of customer options. The options include for example consulting Expert Assistance, browsing the E-catalog, using the Product Locator or using the E-commerce option. Each customer option corresponds to a different screen or set of screens in the user interface. The screen corresponding to each option display other descriptive links or information that help the customer navigate through the system.

From the screen, the customer selects for example the Expert Assistance option by pressing on the appropriate screen area, if the system uses a Touch-screen technology, or selecting a hyperlink with a computer mouse or pointing device for alternative technologies. The user interface provides at all times an indication of the selection process stage that the user is at, by the stage banner showing the five steps leading to product selection and purchase.

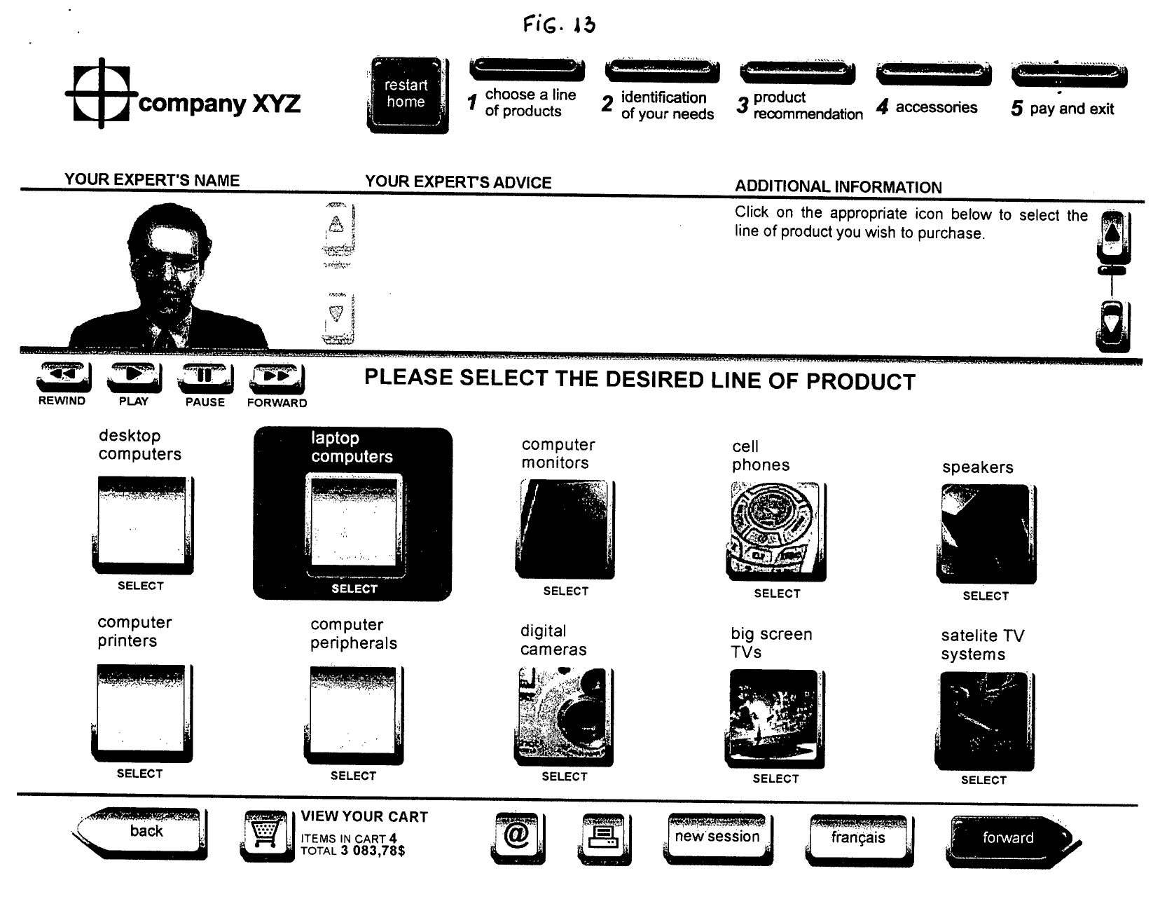

FIG. 13 is a second screen from the exemplary user interface displaying a first portion of the Expert Assistance. In a first step, the user may choose the line of product of interest from a variety of lines of electronic equipment. The user who might be a potential customer chooses a line of product from a product list area of the screen, displaying images and text describing the various lines of product. As previously described, it is expected that various models were defined for each of the available lines of product. For the decision process, the system will then use the model corresponding to the line of product selected by the potential customer.

For purposes of the description of the preferred embodiment, we will describe the case in which the user has selected the ‘laptop computers’ line of product. The selection is confirmed by the selection highlight box on the screen. The customer may advance to the next step by touching the screen area labeled as ‘forward’.

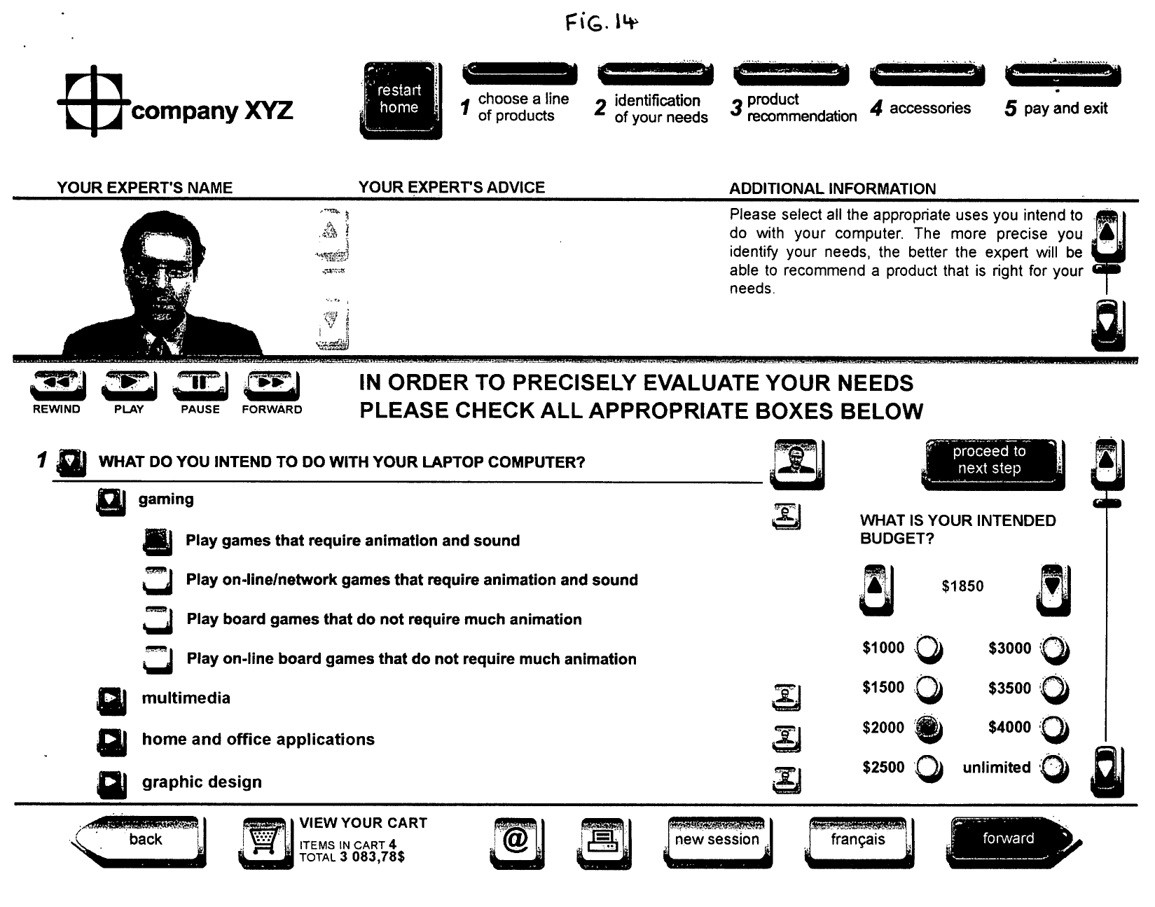

In a next screen, and as illustrated in FIG. 14, the system will evaluate the customer's needs by providing a questionnaire to be answered by the customer. The screen displays multiple prompts including checkboxes, radio buttons, drop-down menus, scroll-down bars, etc. that prompt the customer to input information regarding his particular needs. For example, the screen includes a list of questions on the intended usage of a laptop computer, to which the customer responds by checking boxes, buttons or selecting options from drop-down menus. In an exemplary embodiment, the list of questions includes questions regarding, for example, the customer's interest in: computer games, multimedia, home and office applications, graphic design, etc. The customer may select all uses that apply (check-box questions) or only one among various possibilities (radio button questions). Each question might include specific sub-questions to further define a specific customer need.

At this stage, the customer may also indicate an intended budget for the product to be purchased. The budget can be selected from a set of sample budgets corresponding to the chosen line of product; the customer may as well select the “unlimited” budget option.

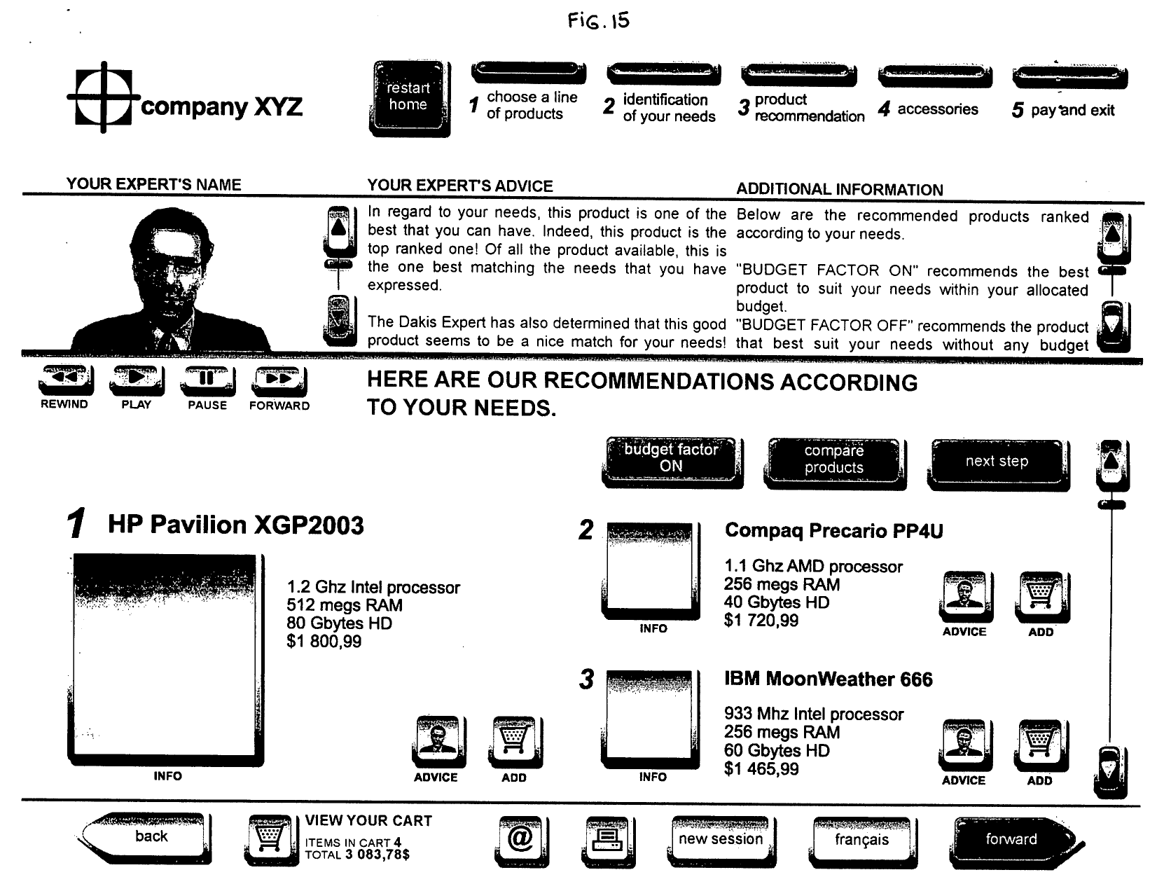

Depending on the information provided to the questionnaire and the needs identified by the system, the customer is provided with various product recommendations. FIG. 15 is another screen of the exemplary user interface. The system displays a list of recommended products in an output list area. A scroll bar system is provided to enable the customer to view all products which cannot fit in the output list area. Every recommended product is listed with a corresponding ranking according to how well it satisfies the specified customer needs. The ranking is based on the information provided by the customer to the system and the score assigned to each product by the system points generator. Each recommended product contains information about the product attribute and characteristics.

Upon selecting a particular instance of a product, the customer is provided with a description of the process used to select the recommended products. The descriptions contain expert advice and additional information, explaining in more detail how the selection criteria specified by the customer was applied on the database of products and provides reasons as to why particular product instances were specifically selected and ranked as such.

Even though the description of the preferred embodiment uses for exemplary purposes a decision system for assisting a customer in purchasing a product, it is to be understood that the method and system of the present invention may be applied to any situation in which an assessment as to the suitability of a finite number of products or services, for example in real estate, healthcare, insurance, etc., must be made with respect to a set of requirements.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A method for assessment of a set of products according to a set of consumer needs:
determining a set of consumer needs relating to a product type
creating a set of questions to be answered by a consumer, said set of questions relating to said set of possible consumer needs
determining a grading for said products for each of said possible consumer needs
obtaining from said consumer answers to said set of questions
determining from said answers a weighting of importance of said consumer needs
using said grading and said weighting to calculate a score for each product of said set of products

2. A method as claimed in claim 1, further comprising the step of using said scores to differentiate between said products such as to suggest to said consumer a product that best satisfies said consumer needs.

3. A method as claimed in claim 1, wherein said determining a grading for said products for each of said possible consumer needs comprises a global ranking of said products for each of said possible consumer needs.

4. A method as claimed in claim 2, further comprising the steps of:
creating a class definition of said product type, said definition comprising attribute specifications for said product type
creating an instance of a product using said class definition and storing it in a database, said instance comprising values for said attribute specifications;
and wherein said step of determining a grading comprises:
determining an association between each question in said set of questions and said attribute specifications, said association representing a grading of how essential a given attribute specification is for satisfying a given consumer need; and
determining a weighting for all said attribute specification values, said weighting quantifying how much a certain attribute specification value satisfies a certain consumer need.

5. A method as claimed in claim 4, wherein said suggested product is part of a set of recommended products.

6. A method as claimed in claim 5, further comprising the step of providing a ranking of said recommended products.

7. A method as claimed in claim 6, wherein said ranking of said recommended products is based on a ratio between said calculated product scores and product prices.

8. A method as claimed in claim 6, further comprising the step of providing an explanation for the choice of each of said recommended products.

9. A method as claimed in claim 1, wherein said product type is a personal computer.

10. A method as claimed in claim 4, wherein said step of calculating a product score comprises:
multiplying said grading value and said weighting value for each attribute specification; and
adding all attribute specification scores to obtain said product score.

11. A method for generating a text containing an assessment of a product according to a set of consumer needs, comprising:
for each consumer need, providing a plurality of text fragments describing said product in consideration of said consumer need, said plurality of text fragments differing from one another in consideration of an importance of said consumer need with respect to a given consumer;
determining for a given consumer, from consumer answers to a questionnaire, a weighting of importance of said consumer needs;
for each consumer need, selecting one of said text fragments according to a weighting of importance of said consumer need;
compiling all selected text fragments into a text for said given consumer.

12. A method as claimed in claimed 11, wherein said plurality of text fragments comprises at least 3 different text options, wherein one of said options is no text.

13. A method as claimed in claim 11, wherein said step of providing a plurality of text fragments, comprises:
providing, for a given product, a text fragment for each said customer need and for each product attribute specification.

14. A method as claimed in claim 13, further comprising:
giving grading values to product attribute specifications depending on how essential a given attribute specification is for satisfying a given consumer need;
giving weighting values to said product attribute specification values according to how well they satisfy said set of consumer needs;
and wherein said selecting one of said text fragments, comprises:
for each product attribute specification, selecting one of said text fragments according to said grading value and weighting value.

15. A method as claimed in claim 14, wherein said method is performed for a set of products, wherein said compiling is performed for said set of products, whereby said text is used to assist a customer in selecting a product from said set of products.
